(19) United States
(12) Patent Application Publication
(10) Pub. No.: US 2026/0281809 A1
(43) Pub. Date: Sep. 17, 2026

(54) Dynamic Adaptive Segmentation for Non-Terrestrial Network (NTN) Voice Solutions

(71) Applicant: Apple Inc., Cupertino, CA (US)

(72) Inventors: Han PU, Shanghai (CN); Bin FENG, Beijing (CN); ChunLei LIN, NT (HK); Pranav TRIPATHI, San Jose, CA (US); Sanjeevi BALASUBRAMANIAN, San Jose, CA (US); Vijay VENKATARAMAN, San Jose, CA (US); Yu WU, Beijing (CN); Yubo ZHOU, Beijing (CN)

(21) Appl. No.: 19/081,594

(22) Filed: Mar. 17, 2025

(51) Int. Cl. H04W 28/06; H04L 5/00; H04W 28/02; H04W 84/06

(52) U.S. Cl. CPC H04W 28/065; H04L 5/0044; H04W 28/0278; H04W 84/06

(57) ABSTRACT

An apparatus configured to determine dynamic segmentation is to be applied to voice packets being transmitted in an uplink (UL) to a network, determine parameters for the dynamic segmentation, and generate, for transmission via a Physical Uplink Shared Channel (PUSCH), one or more segmented voice packets based on the parameters for the dynamic segmentation.

### BACKGROUND

A user equipment (UE) may establish a connection to at least one of multiple different networks or types of networks. For example, the UE may use a non-terrestrial network (NTN) to access a radio access network (RAN) and public land mobile network (PLMN). The term NTN refers to a network utilizing non-terrestrial components (e.g., one or more satellites) for network access.

### SUMMARY

Some example embodiments are related to an apparatus having processing circuitry configured to determine dynamic segmentation is to be applied to voice packets being transmitted in an uplink (UL) to a network, determine parameters for the dynamic segmentation and generate, for transmission via a Physical Uplink Shared Channel (PUSCH), one or more segmented voice packets based on the parameters for the dynamic segmentation.

Other example embodiments are related to a method for determining dynamic segmentation is to be applied to voice packets being transmitted in an uplink (UL) to a network, determining parameters for the dynamic segmentation and generating, for transmission via a Physical Uplink Shared Channel (PUSCH), one or more segmented voice packets based on the parameters for the dynamic segmentation.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 shows an example non-terrestrial network (NTN) architecture according to various example embodiments.

FIG. 5 shows a signaling diagram for dynamic adaptive segmentation (DAS) according to various example embodiments.

FIG. 6 illustrates an UL packet pattern for DAS according to various example embodiments.

FIG. 7 shows a method for implementing DAS when engaging in a voice service according to various example embodiments.

FIG. 8 shows an example of a Medium Access Control Control Element (MAC CE) structure for a recommended bit rate and segmentation indication according to various example embodiments.

FIG. 9 shows a method for indicating a voice codec and segmentation for uplink transmission of voice services according to various example embodiments.

### DETAILED DESCRIPTION

The example embodiments may be further understood with reference to the following description and the related appended drawings, wherein like elements are provided with the same reference numerals. The example embodiments are related to operations performed by a user equipment (UE) or a network component in a non-terrestrial network (NTN) to segment voice packets in a voice communication scenario between the UE and the NTN.

The example embodiments are described with regard to a user equipment (UE). However, reference to a UE is merely provided for illustrative purposes. The example embodiments may be utilized with any electronic component that may establish a connection to a network and are configured with the hardware, software, and/or firmware to exchange information and data with the network. Therefore, the UE as described herein is used to represent any appropriate electronic component.

The example embodiments are also described with regard to a Fifth Generation (5G) New Radio (NR) network. However, reference to 5G NR is merely provided for illustrative purposes. The example embodiments may be utilized with any appropriate type of network that may establish a connection to a UE and exchange information and data with the UE (e.g., 5G-Advanced networks, 6G networks, etc.).

The example embodiments are further described with regard to a 5G NR network integrated with an NTN utilizing one or more satellites to provide UE access to the 5G NR radio access network (RAN). A satellite-based NTN may be deployed by a public land mobile network (PLMN) and may be further integrated with a terrestrial network (TN) of the PLMN. Throughout this description, the non-terrestrial component is described as a satellite. However, any reference to a satellite is only for illustrative purposes and the example embodiments may apply to other types of non-terrestrial components, e.g., airplanes, unmanned aerial vehicles (UAVs), etc.

Voice communications utilizing NTN networks may have a defined packet size. In some scenarios, there may be conditions that make reliable communication between the UE and NTN network difficult using this packet size, e.g., pathloss, satellite position, high block error rate, etc. This may lead to a decrease in voice communication quality for the UE.

The example embodiments are also described with respect to a scenario where the voice communications are being performed in an unacknowledged mode (UM) in the Radio Link Control (RLC) layer. In addition, the Hybrid-Automatic Request (HARQ) feedback may be disabled. However, the example embodiments are not limited to these scenarios, e.g., the UE may be operating in Acknowledged Mode (AM) and/or HARQ feedback may be enabled.

The example embodiments provide operations for a UE to improve voice communication reliability and quality when utilizing NTN networks by segmenting the voice packets termed dynamic segmentation or DAS, e.g., using dynamic voice packet sizes and/or periods. The example embodiments also provide operations for a UE to determine whether to implement DAS. Furthermore, the example embodiments also provide manners of determining a voice coded for the segmented voice packets and manners of signaling the network with respect to the dynamic segmentation and/or voice codec. Each of the example embodiments will be discussed in greater detail below.

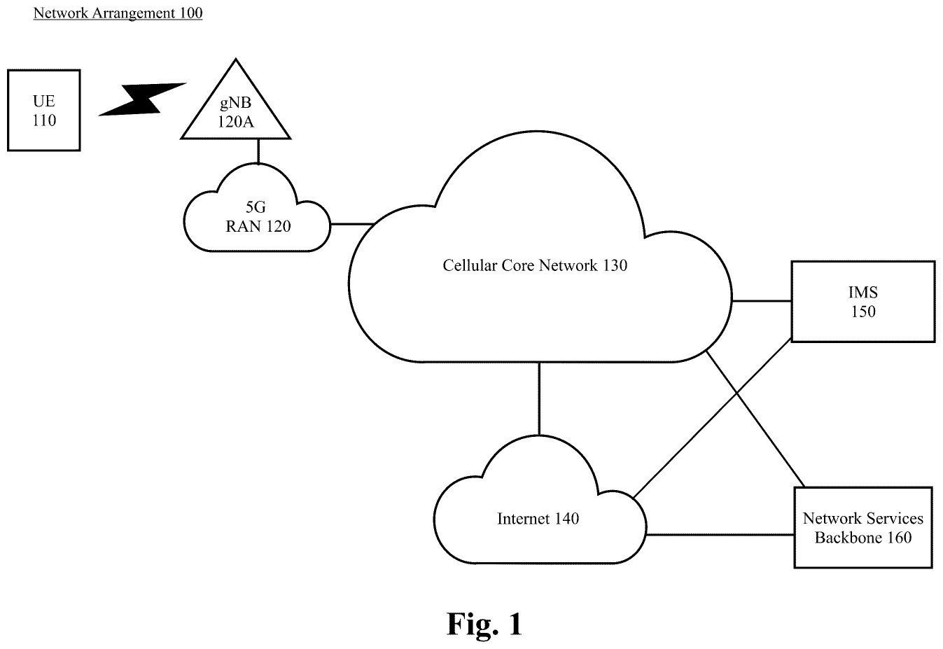

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables, Internet of Things (IoT) devices, etc. the example of a single UE 110 is merely provided for illustrative purposes. An actual network arrangement may include any number of UEs being used by any number of users.

The UE 110 may be configured to communicate with one or more networks. In the example of the network arrangement 100, the network with which the UE 110 may wirelessly communicate is a 5G NR RAN 120. However, the UE 110 may also communicate with other types of networks (e.g., Sixth Generation (6G) networks, 5G advanced networks, 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the example embodiments, the UE 110 may establish a connection with the 5G NR RAN 120. Therefore, the UE 110 may have at least a 5G NR chipset to communicate with the NR RAN 120.

The 5G NR RAN 120 may be a portion of a PLMN that may be deployed by a network carrier (e.g., Verizon, AT&T, T-Mobile, etc.). The 5G NR RAN 120 may include, for example, nodes or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

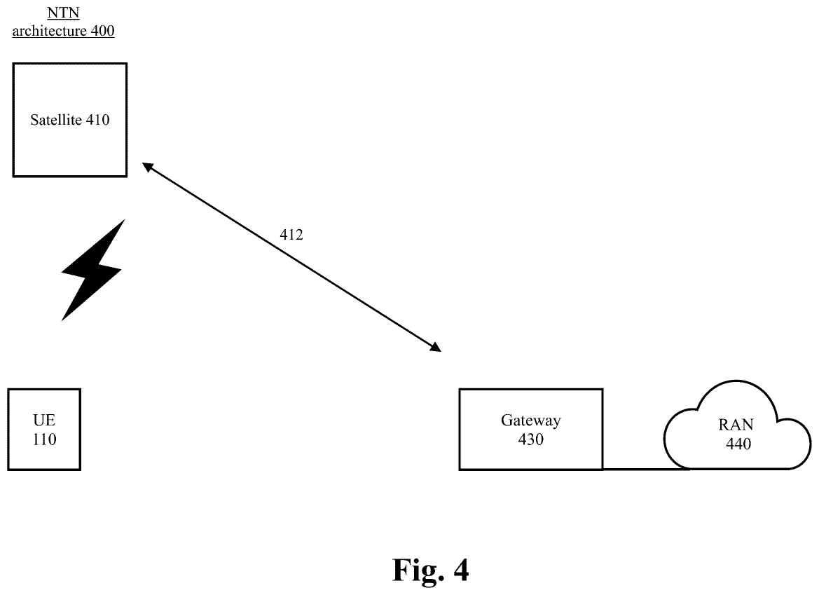

In the example network arrangement 100, the 5G NR RAN 120 includes a base station (e.g., gNB 120A) that may be in a terrestrial network (TN) deployment or a non-terrestrial network (NTN) deployment. For example, a satellite-based system may be integrated with the 5G NR RAN 120 to provide network access to the UE 110 in the NTN deployment and the base station may, in some cases, be located on a non-terrestrial component, e.g., a satellite. An example NTN network architecture will be described in greater detail below with reference to FIG. 4.

The UE 110 may connect to the 5G NR-RAN 120 via the gNB 120A. Any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific node (e.g., the gNB 120A). However, as mentioned above, reference to the 5G NR-RAN 120 is merely for illustrative purposes and any appropriate type of RAN may be used.

In addition to the 5G NR RAN 120, the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140.

The IMS 150 may be described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

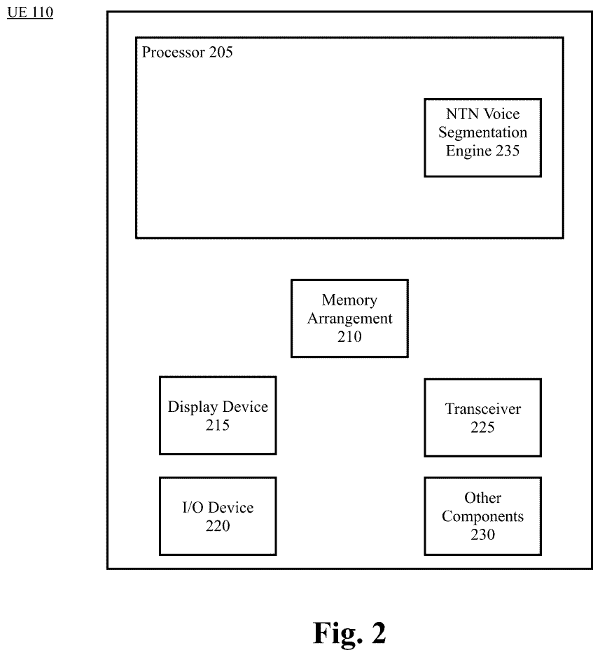

FIG. 2 shows an example UE 110 according to various example embodiments. The UE 110 will be described with regard to the example network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include an NTN voice segmentation engine 235. The NTN voice segmentation engine 235 may perform various operations related to the example embodiments introduced herein. For example, the NTN voice segmentation engine 235 may receive a UL grant from a network and generate segmented voice packets to transmit to the network. These and other operations are described in greater detail below.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode, decode and/or process signals (e.g., signaling from a base station of a network) for implementing any one of the methods described herein.

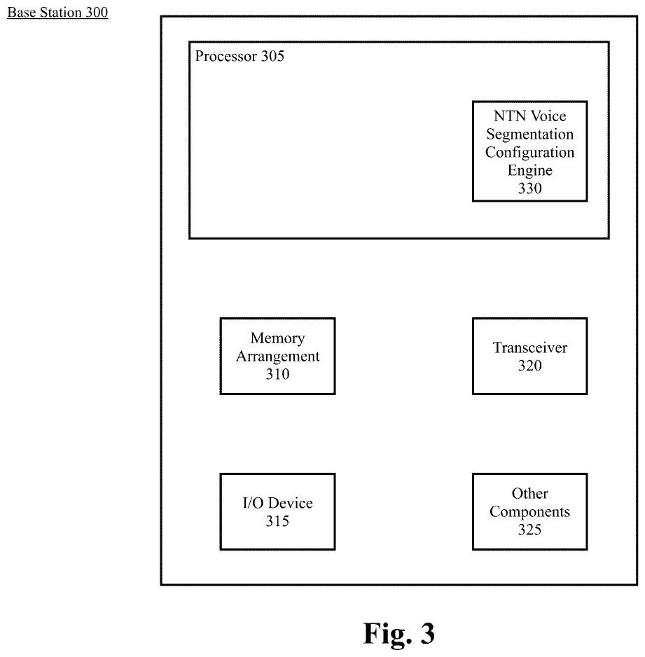

FIG. 3 shows an example base station 300 according to various example embodiments. The base station 300 may represent the gNB 120A or any other type of access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, antenna elements, antenna panels, etc.

The processor 305 may be configured to execute a plurality of engines for the base station 300. For example, the engines may include an NTN voice segmentation configuration engine 330. The NTN voice segmentation configuration engine 330 may perform various operations related to the example embodiments. These operations may include but are not limited to transmitting a UL grant to a UE and receiving a PUSCH of voice packets from the UE. These and other operations are described in greater detail below.

The above noted engine 330 being an application (e.g., a program) executed by the processor 305 is only an example. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The example embodiments may be implemented in any of these or other configurations of a base station.

The memory arrangement 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UEs in the network arrangement 100. The transceiver 320 may operate on a variety of different frequencies or channels (e.g., set of consecutive frequencies). Therefore, the transceiver 320 may include one or more components to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode, decode and/or process signals (e.g., signaling from a UE) for implementing any one of the methods described herein.

FIG. 4 shows an example non-terrestrial network (NTN) architecture 400 according to various example embodiments. An NTN may relate to any network using non-terrestrial components, such as satellites, airplanes, unmanned aerial vehicles (UAVs), etc., to provide network services to a user terminal.

The NTN architecture 400 represents a network arrangement including one or more satellites, which in this example shows a satellite 410 that is integrated with a radio access network (RAN) 440. The RAN 440 may be, for example, the 5G NR RAN 120 described above with respect to FIG. 1. The NTN architecture 400 includes a gateway 430 connecting the RAN 440 with the NTN components. In the NTN architecture 400 of FIG. 4, the gateway 430 and the satellite 410 communicate via feeder links 412. In some NTN deployments, satellites may be served by several gateways simultaneously.

The satellite 410 provides network services to a UE 110 via a service link (not shown). The satellite 410 and the RAN 420 may implement either a transparent payload or a regenerative payload. A transparent payload refers to an arrangement where the satellite 410 receives signals and transmits an amplified version of the signal, with a frequency conversion. For example, the satellite 410 may receive uplink communications from the UE 110 on service link frequencies and transmit an amplified version of the signal to the gateway 430 on feeder link frequencies or may receive downlink communications via the gateway 430 on feeder link frequencies and transmit an amplified version of the signal to the UE 110 on service link frequencies. A regenerative payload refers to an arrangement where the satellite 410 acts as a distributed unit (DU) or a base station (e.g., a gNB), wherein received signals are regenerated with signal-processing techniques (e.g., demodulation, decoding, switching, encoding, modulation, etc.) before being re-transmitted.

The example NTN architecture 400 shown in FIG. 4 is not intended to limit the example embodiments in any way. NTNs may be integrated with the 5G NR RAN and/or other networks in any one of a variety of manners. For example, a typical satellite-based NTN may comprise a low earth orbit (LEO) constellation including an array of satellites and gateways with broad interconnectivity via ground-to-ground station (G2G) links, satellite-to-satellite (S2S) links, ground-to-satellite (G2S) links, and satellite-to-ground (S2G) links. Other types of satellite-based NTNs include geostationary-orbiting (GEO) satellites or medium-earth-orbiting (MEO) satellites.

The different types of NTNs each have respective strengths and weaknesses and may be deployed in a variety of scenarios, depending on the goal to be achieved, e.g., broad coverage across a large region, concentrated coverage in an urban environment or along a highly trafficked route, etc. Thus, the NTN architecture 400 described in FIG. 4 is merely provided for illustrative purposes. The example embodiments may apply to any of these or other configurations of an NTN.

During voice call operations between a UE and an NTN, certain conditions may arise that make reliable communication between the UE and the NTN unreliable. The example embodiments introduce dynamic adaptive segmentation (DAS) that may be used to make communication more reliable between the UE and the NTN. DAS may include the UE segmenting voice packets into smaller packets. The size of the smaller packets may be fixed or dynamic. DAS may also include a dynamic period for transmitting the voice packets.

The UE may adjust the size of the packets and the period in which the packets are transmitted dynamically. For example, the triggering conditions for implementing DAS may include, but are not limited to, radio frequency conditions such as reference signal received power (RSRP), signal to noise ratio (SINR), block error rate (BLER), and pathloss, satellite conditions such as mobility and altitude, predicted BLER, acknowledged mode (AM) feedback (e.g., based on other non-voice types of packets being exchanged) and/or feedback from the application layer (e.g., voice application feedback). These and other example embodiments are described in greater detail below.

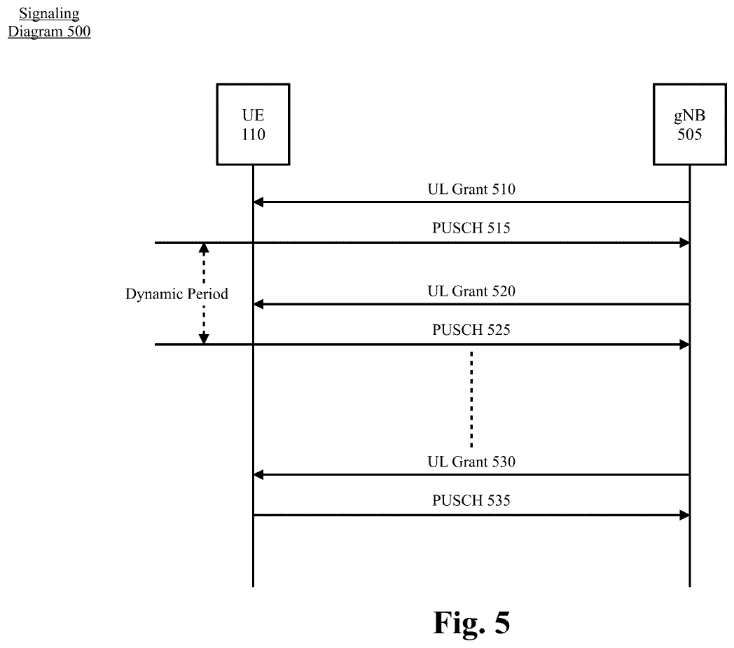

FIG. 5 shows a signaling diagram 500 for dynamic adaptive segmentation (DAS) according to various example embodiments. The signaling diagram 500 includes the UE 110 and a gNB 505 of an NTN and is described with regard to a scenario in which the UE 110 is engaged in a voice call via the gNB 505.

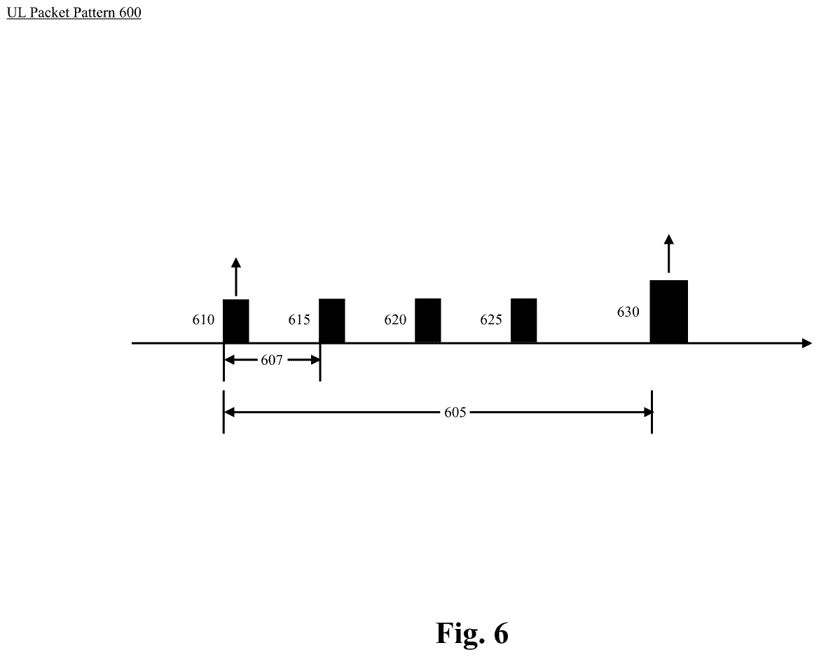

FIG. 6 illustrates a UL packet pattern 600 for DAS according to various example embodiments. The signaling diagram 500 of FIG. 5 will be described in conjunction with the UL packet pattern 600 of FIG. 6.

In 510, the UE 110 may receive an uplink (UL) grant from the gNB 505. The UL grant received by the UE 110 from the gNB 505 may be for a new transmission. For example, the gNB 505 may send the UL grant in a physical downlink control channel (PDCCH).

Upon receiving the UL grant for the new transmission, the UE 110 may determine the amount of voice data that the UE 110 may have to transmit in the UL to the gNB 505. Instead of transmitting all the voice data in the UL buffer to the gNB 505 in response to the UL grant received in 510, the UE 110 may split the voice data into segmented packets to be transmitted to the gNB 505. As described above, the UE 110 may split the voice packets into segmented packets based on any trigger condition determined by the UE 110, e.g., radio frequency (RF) conditions (e.g., RSRP, SINR, BLER, pathloss, etc.), satellite conditions, predicted BLER, etc.

In this example, the UE 110 may determine the number of segmented packets to split the voice data into based on a number of UL slots in a predefined period, the amount of the voice data to be transmitted in the UL and/or the trigger conditions (e.g., as described above). For example, referring to FIG. 6, the predefined period 605 may be 40 ms, but this is not meant to limit the example embodiments in any way. In addition, there may be UL slots to accommodate up to four (4) UL transmissions of voice packets during the predefined period 605. Thus, in this example, the UE 110 may determine the segmented period based on the number of UL slots. For example, in this scenario, the segmented (or dynamic) period 607 may be 10 ms, e.g., 40 ms divided by 4 UL slots for a 10 ms period. The UE 110 may then determine the size of the segmented packets based on amount of voice data and the segmented period. In the example of FIG. 6, the UE 110 has segmented the voice data into four (4) equal size voice packets 610-625. However, the voice packets 610-625 do not have to be of equal size, the UE may split the voice data into any appropriate size packets. In the example of FIG. 6, the voice packets 610-625 are contrasted with a voice packet 630 from a next predefined period that may not be segmented. Again, the number of packets, the size of the packets, the length of the predefined period and the length of the dynamic period of FIG. 6 is only one example and any of these values may be modified according to the various example embodiments.

In 515, the UE 110 may transmit a physical uplink shared channel (PUSCH) to the gNB 505. The PUSCH transmitted by the UE 110 may include the voice packets and a buffer status report (BSR). For example, in 515, the UE 110 may transmit the first segmented voice packet 610 of the voice data. In this scenario, because there is additional voice data to be transmitted, the BSR may indicate to the gNB 505 that additional voice packets are in the buffer of the UE 110.

In 520, the UE 110 may receive a UL grant from the gNB 505 for a new transmission. The gNB 505 may transmit the UL grant to the UE 110 in response to receiving the PUSCH from the UE 110 in 515, e.g., the gNB 505 may transit the UL grant in 520 in response to the BSR indicating that the UE has additional voice packets to transmit.

In 525, the UE 110 may transmit a PUSCH to the gNB 505. The PUSCH transmitted by the UE 110 may be additional segmented packets that were not previously transmitted to the gNB 505, e.g., the voice packet 615 of FIG. 6. The UE 110 may transmit the PUSCH in 525 after a dynamic period 607 determined, for example, as described above. For example, as described above, the dynamic period 607 may be 10 ms, meaning the PUSCH in 525 may be transmitted 10 ms after the PUSCH in 515.

Similar to the PUSCH in 515, the PUSCH in 525 may also contain a BSR indicating whether there are any remaining segmented packets to transmit. For example, if the BSR in the PUSCH in 525 indicates there are remaining segmented packets, the gNB 505 may send another UL grant for a new transmission and the UE 110 may send additional segmented packets in a PUSCH. These transmissions are not shown in FIG. 5, but the segmented voice packet 620 of FIG. 6 may be the voice packet(s) transmitted in this PUSCH.

Since there is still a remaining segmented packet to transmit in the example of FIG. 6, e.g., voice packet 625, the BSR of the previous PUSCH will indicate that there is remaining audio data in the buffer and, in 530, the UE 110 may receive a UL grant for a new transmission from the gNB 505. In 535, the UE 110 may transmit a PUSCH including the remaining segmented voice packets (e.g., voice packet 625) and a further BSR. Again, the PUSCH in 535 may be transmitted in a dynamic period from the previous PUSCH transmission. The dynamic period may be the same dynamic period 607 or the dynamic period may be different if conditions related to DAS implementation have changed.

In this example, the UE 110 no longer has additional segmented packets for this predefined period. Thus, the BSR included in the PUSCH 535 will be zero. This indicates to the gNB 505 that no additional UL grants are to be sent for the current predefined period. Referring to FIG. 6, as described above, the voice packet 630 is for the next predefined period. The signaling described above may continue until the UE 110 is no longer engaged in a voice service via the gNB 505.

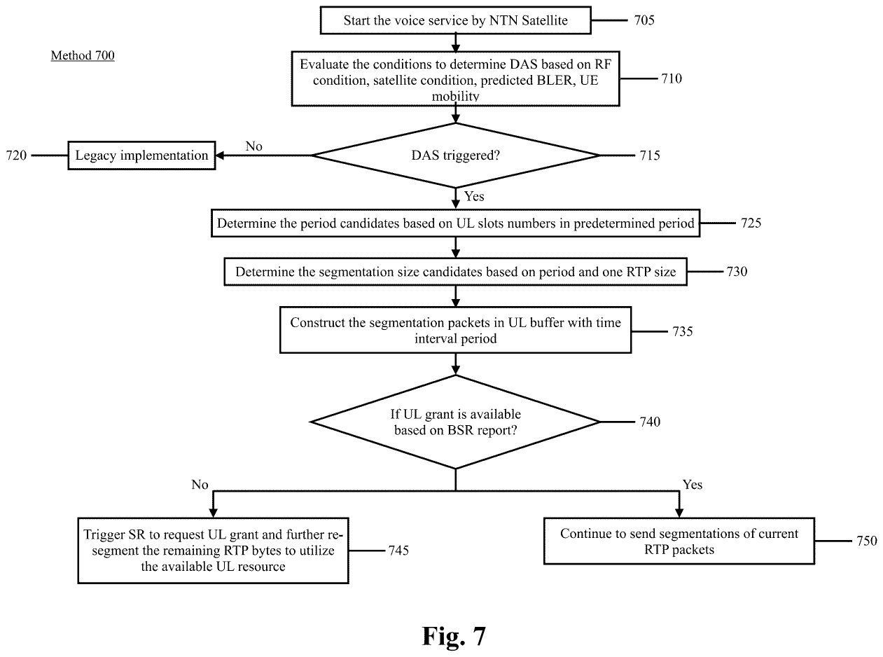

FIG. 7 shows a method 700 for implementing DAS when engaging in a voice service according to various example embodiments. The method 700 of FIG. 7 is described from the perspective of a UE. For illustrative purposes, the UE may be the UE 110 engaged in a voice service via the NTN satellite 410.

In 705, the UE 110 begins a voice service by NTN satellite 410. As described above, the voice packets sent in the voice communication session may be in the UM mode with HARQ disabled but this is not a requirement. In 710, the UE 110 evaluates conditions to determine whether to implement DAS for voice packets. The UE 110 may consider various factors such as RF conditions, satellite conditions, predicted BLER, UE mobility status, etc. The UE 110 may consider only some of the above listed factors or consider additional factors not listed above when determining whether to implement DAS.

The UE 110 evaluates conditions to determine whether factors are above or below certain thresholds. Some example thresholds are provided herein. However, these thresholds are only examples, and other thresholds may be used. In one example, RF conditions may be evaluated by determining whether the RSRP is above or below a threshold RSRP (e.g., −120 dBm). DAS may be triggered when the RSRP is less than the threshold RSRP, which may be referred to as “threshold_RSRP,” e.g., when the RSRP is below the threshold, it is less likely that a large voice packet will be successfully delivered to the satellite 410 and therefore DAS may be implemented to reduce the size of the voice packet. In another example, the RF condition that is evaluated may be whether a pathloss is greater than a threshold pathloss, which may be referred to as “threshold_Pathloss.” If the pathloss is greater than the threshold, DAS may be implemented. Similarly, the UE 110 may evaluate other RF conditions to determine whether to implement DAS. In addition, these RF conditions may be evaluated singularly or in combination with other RF conditions, e.g., RSRP and pathloss may be evaluated together to determine whether DAS is to be implemented. The thresholds for evaluating whether DAS is to be implemented may be set based on any factors including being hard encoded in standards (e.g., 3GPP Technical Specifications), operating experience, artificial intelligence/Machine learning models, etc.

In a further example, satellite conditions may be evaluated by determining if the satellite altitude is above or below a threshold altitude (e.g., 30 degree elevation). DAS may be triggered when the satellite altitude is greater than the threshold altitude, which may be referred to as “threshold_altitude.”

In an additional example, the predicted BLER may be evaluated by determining whether it is above or below a threshold predicted BLER (e.g., 20%). DAS may be triggered when the predicted BLER is greater than the threshold predicted BLER, which may be referred to as “threshold_predictedBLER.”

In an additional example, the UE mobility status may be evaluated by determining whether it is above or below a threshold UE mobility (e.g., 300 km/h). DAS may be triggered when the predicted BLER is greater than the threshold predicted BLER, which may be referred to as “threshold UE mobility.”

The above provided various examples of trigger conditions for implementing DAS. This is not an exhaustive list, and other conditions may be evaluated for determining whether to implement DAS. In addition, any of the above example conditions or other conditions may be evaluated on their own or in combination with one or more conditions to determine whether DAS is to be implemented by the UE 110.

In 715, the UE 110 determines if DAS has been triggered. The UE 110 may determine if DAS has been triggered depending on whether the conditions evaluated in 710 triggered DAS.

If DAS is not triggered, in 720, a legacy implementation of transmitting voice packets in the UL may be conducted by the UE 110.

If DAS is triggered, in 725, the UE 110 determines the segmentation period candidates. The segmentation period candidates may be based on the number of UL slots in the predetermined period, e.g., based on a Time Division Duplexing (TDD) configuration, Frequency Division Duplexing (FDD) configuration, etc. In the example started above with reference to FIG. 6, the predetermined period is 40 ms and the number of UL slots was 4 resulting in a candidate segmented period of 10 ms. However, this is only an example, in other examples there may be 8 available UL slots in 40 ms resulting in a candidate segmented period of 5 ms, or 2 available UL slots in 40 ms resulting in a candidate segmented period of 20 ms, etc. In addition, the example of the predetermined period being 40 ms is also only an example and a longer or shorter predetermined period may be defined.

In 730, the UE 110 determines the segmentation size candidates. For example, the UE 110 may determine the real-time transport protocol (RTP) size of the voice packets generated by an application layer implementing the voice services. The segmented packets, e.g., the segmented voice packets illustrated in FIG. 6, may be from the standpoint of Layer 2. The UE 110 may use the RTP size to determine the segmented packet size. For example, the UE 110 knows the segmented period candidates determined in 725, the RTP size and the current conditions (e.g., RF conditions, satellite conditions, etc. determined in 710). The UE 110 may use this information to determine the segmented size in 730. To provide one example, the RTP size may be 80 bytes per 20 ms and the candidate segmented period may be 10 ms. Thus, in this example, the segmented size may be determined to be 40 bytes every 10 ms. In another example, the RTP size may be 80 bytes per 20 ms and the candidate segmented period may be 5 ms. Thus, in this example, the segmented size may be determined to be 20 bytes every 5 ms. In a further example, the RTP size may be 80 bytes per 20 ms and the candidate segmented period may be 5 ms similar to the previous example. However, in this example, the UE 110 may determine that the RF conditions, while warranting using DAS, may not be bad enough to use the lowest possible packet size. Thus, the UE may still determine that the segmented packet size may be 40 bytes that may be transmitted every 5 ms or the segmented period may be extended to 10 ms. Again, these are only examples, and various conditions and values may be used to determine the segmented packet size when DAS is implemented.

In 735, the UE 110 constructs the segmentation packets. The segmentation packets are constructed in UL buffer with time interval period. In one embodiment, the UE 110 constructs the segmentation packets based on segmentation period and segmentation size. The UE 110 may construct the segmentation packets based on additional factors or based on either segmentation period or segmentation size.

In 740, the UE 110 determines whether a UL grant is available. The UE 110 determines if a UL grant is available, e.g., did the gNB send a UL grant such as the UL grants 520 and 530 based on the BSR transmitted by the UE. If a UL grant is not available, the UE 110 continues the method in 745. If a UL grant is available, the UE 110 continues the method in 750.

In 745, when a UL grant is not available to the UE 110, the UE 110 may trigger a scheduling request (SR) to request a UL grant from the network. In this example, the UE 110 may re-segment the remaining RTP bytes to utilize the available UL resources. For example, sending the SR and receiving the UL grant in response to the SR may take time during the predetermined period and this time has to be accounted for in the segmentation process.

In 750, when a UL grant is available to the UE 110, the UE 110 continues to send segmentations of the current RTP packets, e.g., similar to the signaling diagram 500 of FIG. 5.

The method 700 described a method for implementing DAS. However, implementing DAS may not be static determination and the various values, e.g., segmentation size, segmentation period, etc., may also not be static determination. For example, the UE may be in a mobility state and the RF conditions may be constantly changing. The UE may continuously evaluate the RF conditions to determine if DAS is to be implemented and the parameters that should be used if DAS is implemented. Similarly, the satellite may be moving and, for example, the altitude of the satellite with respect to the UE may be constantly changing. Thus, the UE may continuously evaluate the satellite conditions for implementing DAS. These changing conditions (e.g., RF conditions, satellite conditions, etc.) may trigger re-segmentation for the segmentation period and/or segmentation size.

In the above example embodiments, the UE determined based on individual voice packets and current conditions whether the voice packets should be segmented, e.g., should DAS be implemented. The following example embodiments describe a UE providing the network with a preferred voice codec indication. This voice codec indication may also include a segmentation indication.

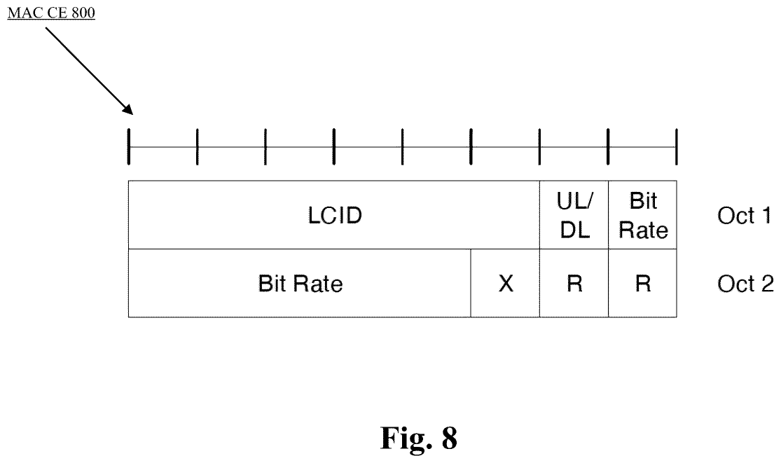

FIG. 8 shows an example of a MAC CE structure 800 for a recommended bit rate and segmentation indication according to various example embodiments. In this example, the MAC CE 800 is a single-octet bitmap that contains two reserved bits (R). A UE may use the MAC CE 800 to trigger fast voice codec adaptation.

The value of the reserved bits may indicate whether dynamic adaptive segmentation (DAS) is enabled. For example, an R value of “00” may indicate that DAS is not enabled. An R value of “01” may indicate that DAS is enabled, and a higher bit rate is recommended. An R value of “10” may indicate that DAS is enabled, and a lower bit rate is recommended. An R value of “11” may remain reserved for future use. A UE may use this example MAC CE to indicate to a network whether DAS is enabled and whether a higher bit rate or lower bit rate is recommended for use.

Example conditions for selecting the higher bit rate or lower bit rate are described in more detail below. However, the point of using the higher bit rate or the lower bit rate is that when DAS is used and conditions are generally good, DAS and a higher bit rate may allow for more data to be transmitted during each predetermined period because the size of the segmented packets may be larger. However, when DAS is used and conditions are generally bad, DAS and a lower bit rate may be used to maintain the RTP quality under the bad conditions.

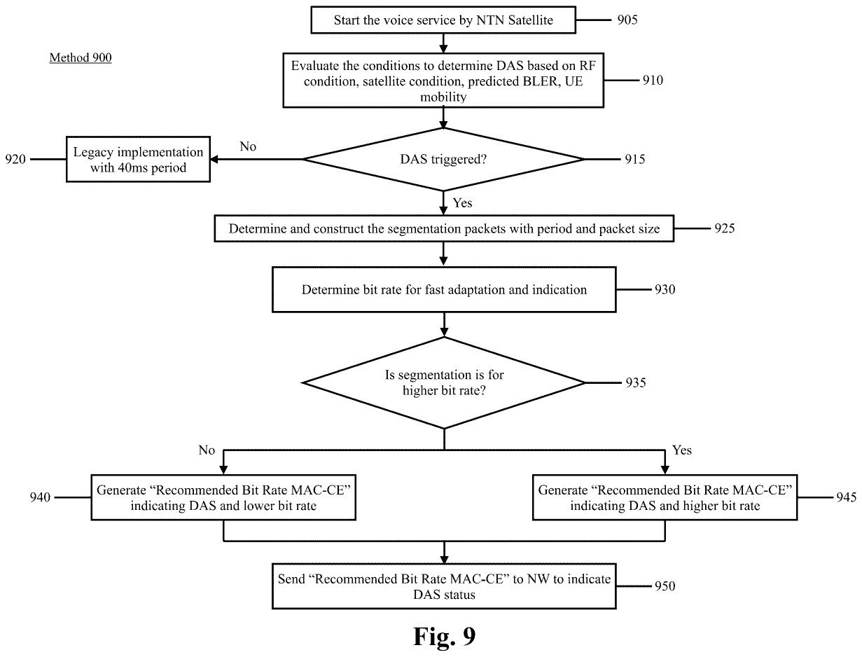

FIG. 9 shows a method 900 for indicating a voice codec and segmentation for uplink transmission of voice services according to various example embodiments. The method 900 of FIG. 9 is described from the perspective of a UE. For illustrative purposes, the UE may be the UE 110 engaged in a voice service via the NTN satellite 410.

In 905, the UE begins a voice service by NTN satellite. In 910, the UE 110 evaluates conditions to determine whether to implement DAS for voice packets. The UE 110 considers factors such as RF conditions, satellite conditions, and predicted BLER. The operations performed by the UE 110 in 910 may be similar to the operations described for the UE in 710 above.

In 915, the UE 110 determines if DAS has been triggered based on the conditions evaluated in 910. If DAS is not triggered, in 920, a legacy implementation of transmitting voice packets in the UL may be conducted by the UE 110. If DAS is triggered, in 925, the UE 110 implements procedures for determining a segmentation period and a segmentation size. The UE may also construct the segmented voice packets. The operations performed in 925 may be similar to the operations performed in 725, 730 and 735 as described above with reference to FIG. 7.

In 930, the UE 110 determines whether the DAS is to be implemented with a higher bit rate or a lower bit rate. The UE 110 may evaluate various conditions to determine whether the higher bit rate or lower bit rate is to be recommended for use with the segmented packets. For example, the UE 110 may recommend using the higher bit rate when there are a sufficient number of available UL slots, and the power status of the UE 110 is above a threshold. For example, when the UE is experiencing these conditions, segmented packets may carry more bits of the RTP packets. On the other hand, if the UE 110 is experiencing bad conditions, e.g., based on measured thresholds, the UE 110 may use DAS to maintain the RTP quality by recommending lowering the bit rate for the segmented packets, e.g., each segmented packet carries less bits. The conditions that are evaluated for using the higher bit rate or lower bit rate may be the same conditions described above for evaluating whether DAS is to be implemented (e.g., RF conditions, satellite conditions, predicted BLER, AM feedback, etc.) and may include the same or different thresholds. In addition, different conditions may also be used singularly or in combination with other conditions to determine the use of the higher or lower bit rate. As described above, in one example, these different conditions may include a power state of the UE but there may be other types of conditions. The thresholds for the higher or lower bit rates may be set based on any factors including being hard encoded in standards (e.g., 3GPP Technical Specifications), operating experience, artificial intelligence/machine learning models, etc. In addition, the exact values for the higher or lower bit rates may be set in the same manner, e.g., standards, operating experience, etc.

In 935, the UE 110 determines whether the segmented packets are for a higher bit rate or a lower bit rate. If the segmented packets are for a higher bit rate, in 940, the UE 110 generates a fast adaptation indication to be sent to the network indicating the segmented packets are for a higher bit rate. For example, the fast adaptation indication may be the MAC CE 800 described above with reference to FIG. 8. In this example embodiment, the UE 110 generates the MAC CE 800 with the bitmap value “01” to indicate that segmentation is being used, and the segmented packets are to be transmitted at a higher bit rate.

If the segmented packets are for a lower bit rate, in 945, the UE 110 generates a fast adaptation indication to be sent to the network indicating the segmented packets are for a lower bit rate. Again, the fast adaptation indication may be the MAC CE 800 described above with reference to FIG. 8. In this example embodiment, the UE 110 generates the MAC CE 800 with the bitmap value “10” to indicate that segmentation is being used, and the segmented packets are to be transmitted at a lower bit rate. While the example embodiments are described as using the MAC CE 800 as the fast adaptation indication, the UE may signal the network as to the information described above using other types of signaling, e.g., Radio Resource Control (RRC) signaling, UL control information (UCI), etc.

In 950, the UE 110 transmits the MAC CE 800 to the network. The MAC CE 800 that is transmitted to the gNB 505 indicates to the network whether DAS has been triggered. The MAC CE 800 further indicates to the network whether the segmented packets are to be transmitted at a higher bit rate or lower bit rate when DAS is triggered.

### Examples

In a first example, a method, comprising determining dynamic segmentation is to be applied to voice packets being transmitted in an uplink (UL) to a network, determining parameters for the dynamic segmentation and generating, for transmission via a Physical Uplink Shared Channel (PUSCH), one or more segmented voice packets based on the parameters for the dynamic segmentation.

In a second example, the method of the first example, wherein determining dynamic segmentation is to be applied is based on one of (i) a radio frequency (RF) condition with the network, (ii) a satellite condition of a satellite of the network, (iii) a predicted block error rate (BLER) with the network, (iv) acknowledged mode (AM) feedback from the network for packets exchanged with the network that are not the one or more segmented voice packets, (v) feedback from an application layer implementing a voice service generating real-time transport protocol (RTP) voice packets or (vi) a mobility status of a UE.

In a third example, the method of the second example, wherein the RF condition comprises one or more of reference signal received power (RSRP), signal to noise ratio (SINR), block error rate (BLER) or pathloss.

In a fourth example, the method of the second example, wherein the satellite condition comprises one or more of a mobility condition of the satellite or an altitude of the satellite.

In a fifth example, the method of the first example, wherein the parameters for the dynamic segmentation comprise one or more of a period for transmitting the one or more segmented voice packets or a size of the one or more segmented voice packets.

In a sixth example, the method of the fifth example, wherein determining the period for transmitting the one or more segmented voice packets is based at least on a number of UL slots in a predetermined period for transmitting the one or more segmented voice packets.

In a seventh example, the method of the fifth example, wherein determining the size of the one or more segmented voice packets is based at least on a period for transmitting the one or more segmented voice packets or a size of real-time transport protocol (RTP) voice packets that are segmented to generate the one or more segmented voice packets.

In an eighth example, the method of the first example, wherein the PUSCH transmitting the one or more segmented voice packets comprises a buffer status report (BSR) indicating whether there are any remaining of the one or more segmented voice packets to be transmitted.

In a ninth example, the method of the first example, further comprising processing, based on signaling from the network, an indication of a UL grant, wherein the PUSCH is transmitted in resources indicated by the UL grant.

In a tenth example, the method of the first example, further comprising determining that there is no UL grant comprising resources to transmit the one or more segmented voice packets, generating, for transmission to the network, a scheduling request (SR) comprising a request for resources to transmit the one or more segmented voice packets.

In an eleventh example, the method of the first example, wherein the one or more segmented voice packets are transmitted in unacknowledged mode in a Radio Link Control (RLC) layer with no hybrid automatic repeat request (HARQ) for a Physical (PHY) layer.

In a twelfth example, the method of the first example, wherein the one or more segmented voice packets are generated at a layer 2 (L2).

In a thirteenth example, the method of the first example, further comprising determining whether the one or more segmented voice packets are to be transmitted at one of a first bit rate or a second bit rate, wherein the first bit rate is higher than the second bit rate.

In a fourteenth example, the method of the thirteenth example, wherein determining whether the one or more segmented voice packets are to be transmitted at the one of the first bit rate or the second bit rate based on one of (i) a radio frequency (RF) condition with the network, (ii) a satellite condition of a satellite of the network, (iii) a predicted block error rate (BLER) with the network, (iv) acknowledged mode (AM) feedback from the network for packets exchanged with the network that are not the one or more segmented voice packets, (v) feedback from an application layer implementing a voice service generating real-time transport protocol (RTP) voice packets, (vi) a number of UL slots in a predetermined period for transmitting the one or more segmented voice packets or (vii) a power status of the apparatus.

In a fifteenth example, the method of the thirteenth example, further comprising generating, for transmission to the network, a fast adaptation indication indicating that dynamic segmentation is being used and the one of the first bit rate or the second bit rate at which the one or more segmented voice packets are to be transmitted.

In a sixteenth example, the method of the fifteenth example, wherein the fast adaptation indication comprises a Medium Access Control Control Element (MAC CE) comprising a bitmap indicating that dynamic segmentation is being used and the one of the first bit rate or the second bit rate at which the one or more segmented voice packets are to be transmitted.

In a seventeenth example, the method of the first example, wherein the network comprises a non-terrestrial network (NTN).

In an eighteenth example, a processor configured to perform any of the methods of the first through seventeenth examples.

In a nineteenth example, a user equipment (UE) configured to perform any of the methods of the first through seventeenth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. In a further example, the example embodiments of the above-described method may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

Although this application described various aspects each having different features in various combinations, those skilled in the art will understand that any of the features of one aspect may be combined with the features of the other aspects in any manner not specifically disclaimed or which is not functionally or logically inconsistent with the operation of the device or the stated functions of the disclosed aspects.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalents.

What is claimed:

1. An apparatus comprising processing circuitry configured to:
determine dynamic segmentation is to be applied to voice packets being transmitted in an uplink (UL) to a network;
determine parameters for the dynamic segmentation; and
generate, for transmission via a Physical Uplink Shared Channel (PUSCH), one or more segmented voice packets based on the parameters for the dynamic segmentation.

2. The apparatus of claim 1, wherein the processing circuitry determines dynamic segmentation is to be applied based on one of (i) a radio frequency (RF) condition with the network, (ii) a satellite condition of a satellite of the network, (iii) a predicted block error rate (BLER) with the network, (iv) acknowledged mode (AM) feedback from the network for packets exchanged with the network that are not the one or more segmented voice packets, (v) feedback from an application layer implementing a voice service generating real-time transport protocol (RTP) voice packets or (vi) a mobility status of a UE.

3. The apparatus of claim 2, wherein the RF condition comprises one or more of reference signal received power (RSRP), signal to noise ratio (SINR), block error rate (BLER) or pathloss.

4. The apparatus of claim 2, wherein the satellite condition comprises one or more of a mobility condition of the satellite or an altitude of the satellite.

5. The apparatus of claim 1, wherein the parameters for the dynamic segmentation comprise one or more of a period for transmitting the one or more segmented voice packets or a size of the one or more segmented voice packets.

6. The apparatus of claim 5, wherein the processing circuitry determines the period for transmitting the one or more segmented voice packets based at least on a number of UL slots in a predetermined period for transmitting the one or more segmented voice packets.

7. The apparatus of claim 5, wherein the processing circuitry determines the size of the one or more segmented voice packets based at least on the period for transmitting the one or more segmented voice packets or a size of real-time transport protocol (RTP) voice packets that are segmented to generate the one or more segmented voice packets.

8. The apparatus of claim 1, wherein the PUSCH on which the one or more segmented voice packets are transmitted comprises a buffer status report (BSR) indicating whether there are any remaining of the one or more segmented voice packets to be transmitted.

9. The apparatus of claim 1, wherein the processing circuitry is further configured to:
process, based on signaling from the network, an indication of a UL grant, wherein the PUSCH is transmitted in resources indicated by the UL grant.

10. The apparatus of claim 1, wherein the processing circuitry is further configured to:
determine that there is no UL grant comprising resources to transmit the one or more segmented voice packets; and
generate, for transmission to the network, a scheduling request (SR) comprising a request for resources to transmit the one or more segmented voice packets.

11. The apparatus of claim 1, wherein the one or more segmented voice packets are transmitted in unacknowledged mode in a Radio Link Control (RLC) layer without hybrid automatic repeat request (HARQ) for a Physical (PHY) layer.

12. The apparatus of claim 1, wherein the one or more segmented voice packets are generated at a layer 2 (L2).

13. The apparatus of claim 1, wherein the processing circuitry is further configured to:
determine whether the one or more segmented voice packets are to be transmitted at one of a first bit rate or a second bit rate, wherein the first bit rate is higher than the second bit rate.

14. The apparatus of claim 13, wherein the processing circuitry determines whether the one or more segmented voice packets are to be transmitted at the one of the first bit rate or the second bit rate based on one of (i) a radio frequency (RF) condition with the network, (ii) a satellite condition of a satellite of the network, (iii) a predicted block error rate (BLER) with the network, (iv) acknowledged mode (AM) feedback from the network for packets exchanged with the network that are not the one or more segmented voice packets, (v) feedback from an application layer implementing a voice service generating real-time transport protocol (RTP) voice packets, (vi) a number of UL slots in a predetermined period for transmitting the one or more segmented voice packets or (vii) a power status of the apparatus.

15. The apparatus of claim 13, wherein the processing circuitry is further configured to:
generate, for transmission to the network, a fast adaptation indication indicating that dynamic segmentation is being used and the one of the first bit rate or the second bit rate at which the one or more segmented voice packets are to be transmitted.

16. The apparatus of claim 15, wherein the fast adaptation indication comprises a Medium Access Control Control Element (MAC CE) comprising a bitmap indicating that dynamic segmentation is being used and the one of the first bit rate or the second bit rate at which the one or more segmented voice packets are to be transmitted.

17. The apparatus of claim 1, wherein the network comprises a non-terrestrial network (NTN).
